(19) United States
(12) Patent Application Publication
(10) Pub. No.: US 2011/0136574 A1
(43) Pub. Date: Jun. 9, 2011

(54) Interactive music game

(75) Inventor: Scott C. Harris, Rancho Santa Fe, CA (US)

(73) Assignee: HARRIS TECHNOLOGY, LLC, Rancho Santa Fe, CA (US)

(21) Appl. No.: 12/630,823

(22) Filed: Dec. 3, 2009

(51) Int. Cl. A63F 13/00; A63F 9/24

(52) U.S. Cl. 463/35; 463/36

(57) ABSTRACT

An interactive game and controller that has advanced functions. The controller may be reconfigurable between different configurations, each representing a different instrument. The game can also reconfigure the controller, both to change the function of the controller, but also to change its other characteristics, such as the sound it produces, and the way it reacts to playing notes.

### BACKGROUND

Different systems are known in which players play in a virtual music group along with one another and/or under computer guidance.

Games such as guitar hero and rock band have been known, in which players use peripheral controllers in the shape of an instrument to simulate the playing along with music.

It is also known to carry out recording from multiple different locations over the Internet.

### SUMMARY

The present application describes a special interactive game, carried out on a game console or computer, which provides additional realism for the game and additional realistic parts.

### BRIEF DESCRIPTION OF THE DRAWINGS

### In the Drawings

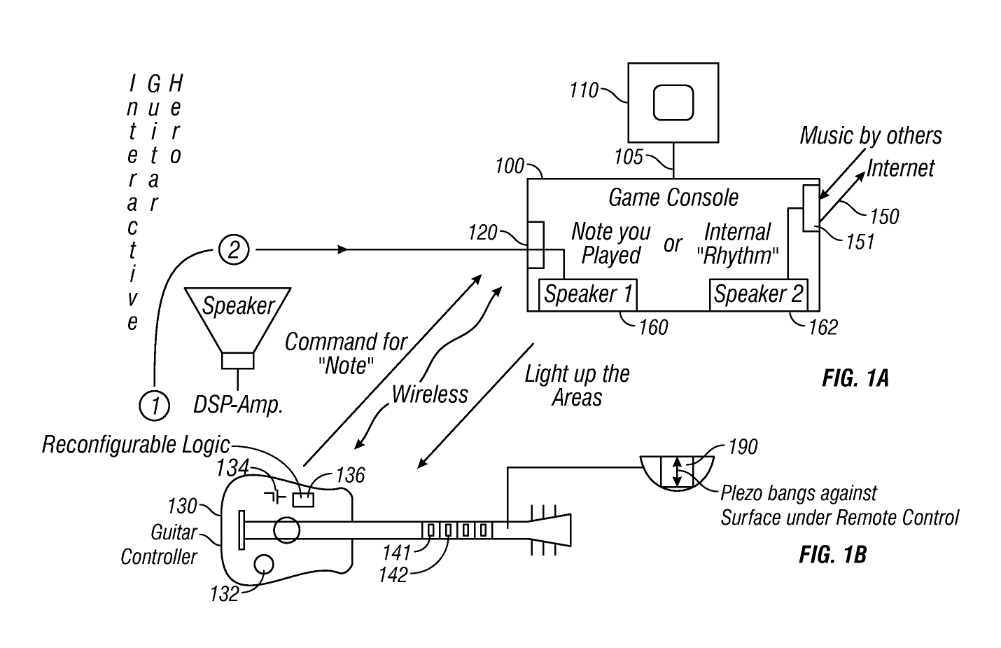

FIG. 1A shows a game system with a controller;

FIG. 1B shows a cross section of the controller;

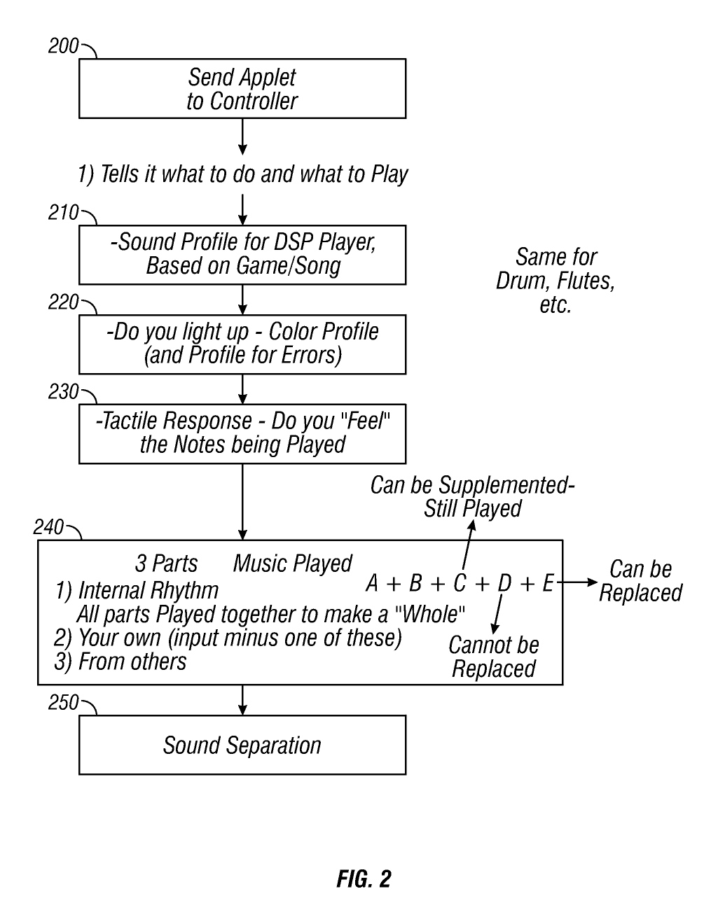

FIG. 2 shows a flowchart of operation;

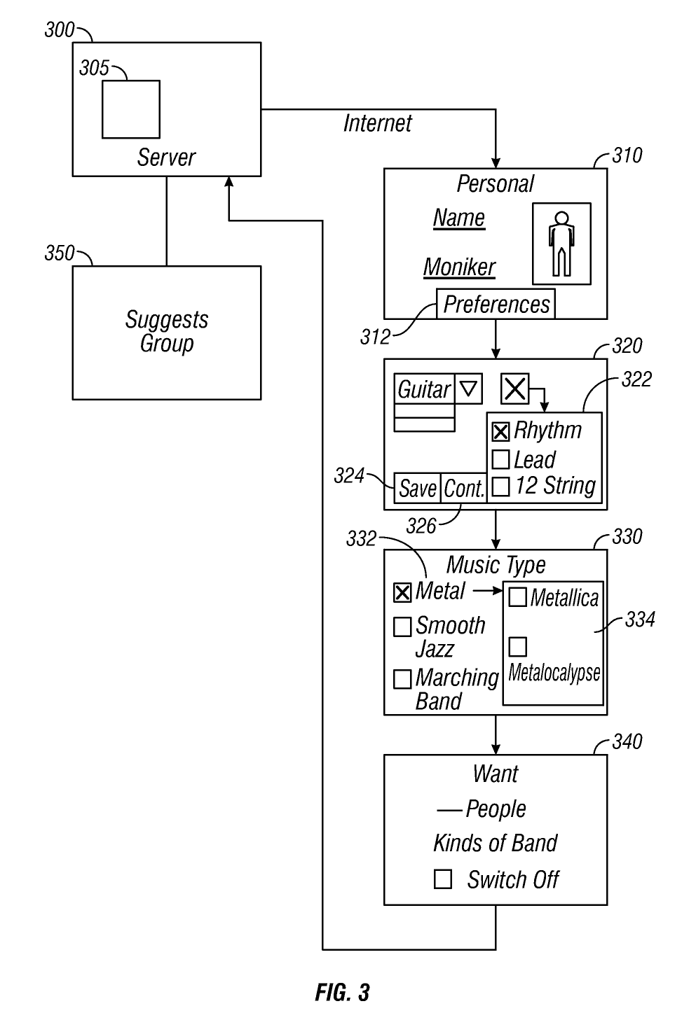

FIG. 3 shows screens of a controlling program;

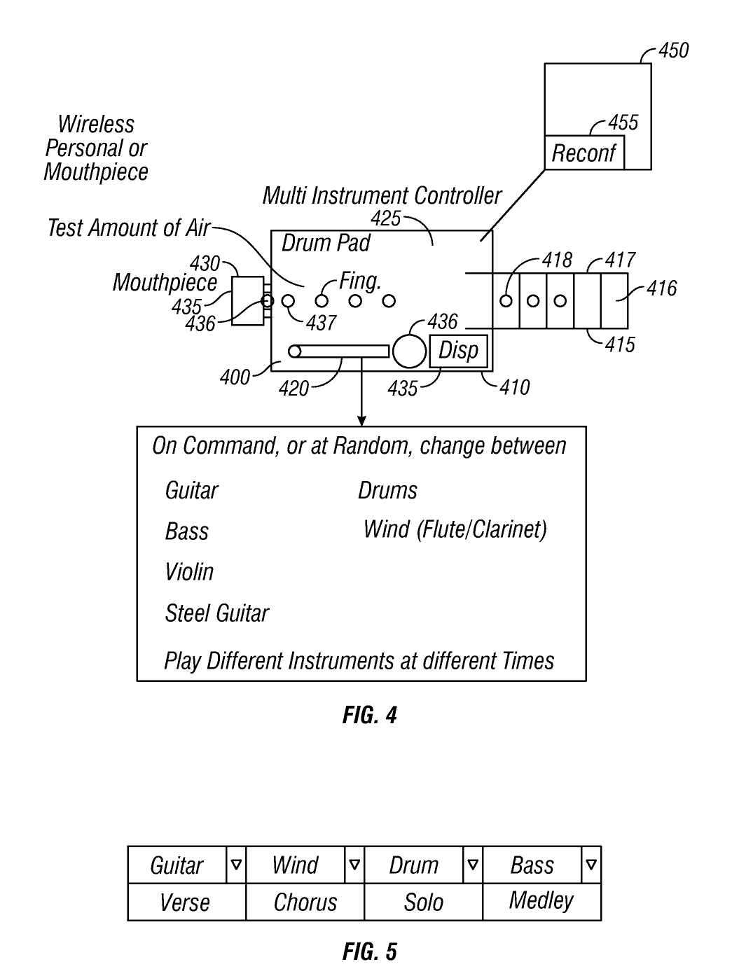

FIG. 4 shows a reconfigurable controller; and

FIG. 5 shows a pull down menu.

### DETAILED DESCRIPTION

An embodiment as shown in FIG. 1A has a game console 100 connected to a display unit 110 which may be a television or a dedicated monitor. In one embodiment, the game controller 100 can be a personal computer, and the connection between the console in that case the computer 100 and the display 110 is a display connection such as DVI or HDMI. The display connection 105 is shown as being wired, but can also be wireless. The game can also be in a portable handheld game where the controller itself includes the game software and processor.

The console 100 also includes an input port 120 which receives wireless communication from a game controller. Another embodiment may use a wired connection. In the embodiment, the game controller may be a guitar shaped controller 130 or in other embodiments, can be in some other shape, e.g., the shape of some other instrument. The shaped controller 130 may also include a speaker 132 therein. In order to drive the speaker, the controller may include a battery shown as 134, as well as circuitry for audio amplification 136. The same battery 134 may drive both the wireless connection, and also the connection and amplification carried out by the amplification 136.

In an embodiment, two-way communication is carried out. The controller 130 sends commands to create musical notes, to the console 100. These commands represent notes being played by the user on the controller 130. The user plays notes on the controller as though they are playing an electronic version of the musical instrument.

The controller 130 may also send other information to the computer.

The console 120 sends information to the controller, including feedback information which creates feedback to the user of the controller.

The feedback may be created by feedback-creating parts in the controller. FIG. 1B shows a cross-section of the controller along the line 2-2. In this cross-section, there is a piezo-driven device 190 that is driven by the internal battery 134. One of the feedback controls sent from the game console includes a command to “bang”, causing the piezoelectric device to press for example a weight or a hammer against the surface.

In an embodiment, the controller has a processor therein, which executes a routine that is downloaded to the game console. This routine may be part of the game that is being run on the console. In an embodiment, the routine that is run on the controller is an “applet” downloaded to the controller.

A flowchart of the operation is shown in FIG. 2. At 200, the applet is sent to the controller, and the controller executes this applet in order to carry out the operations. The game console can send different programs to the controller, which control how the controller reacts to the game and for to the user's moves in the game. In one embodiment, a programmable device may be used in the controller to enable the controller to carry out many different functions.

In an embodiment, the device 136 can be reconfigurable logic, such as a digital signal processor “DSP” or a programmable device such as a field programmable gate array or FPGA. A part of reconfigurable logic may reconfigured into an audio amplifier to carry out the audio amplification. Other parts carry out other functions requested by the applet according to the flowchart of FIG. 2.

The applet is sent to the controller at 200. The applet may tell the controller 130 what to do and what to play. Different things are included within the applet. One of those things may be a sound profile at 210. The reconfigurable logic may reconfigure according to the profile. For example, some songs may require that the sound that is produced have a certain tonality, other have a different tonality. The guitar tonality may cause the logic to configure in a certain different ways, for example, as compared with percussion tonality.

In another embodiment, prestored profiles may be used, without requiring reconfigurable logic in the controller 130.

At 220, the system sends an a color and error profile. In one embodiment, the controller may have light up areas which can be lit when it is time to play using those areas. The areas can be frets shown as 141, 142. These light up frets may light up according to commands sent by the game console, to aid the user for example in determining where they should press for each note.

When there is an error, that is the user presses a wrong note, this may cause a buzzing sound, or cause some tactile response in the controller.

230 represents a part of the applet that defines the tactile response profile. For example, this can represent a responsive feeling for the notes being played, as a response to that playing. They can be for example played to the user as a single sound, or they can be or they can cause the user, for example, to feel a special custom profile, that is defined according to the downloaded applet.

In one embodiment, the tactile response may make a special feeling when a wrong note is played. This tells the user that they have played the wrong note, but has the unexpected advantage that only the local user feels that wrong note, and any other users playing the game may not get any indication of that wrong note.

240 represents the music division. According to an embodiment, the music to be played has three separated parts. A first of the separated parts is the internal rhythm provided by the game. A second part is “your own” part of the music, the music being actually played by the local user. A third part includes portions of the music that are played by other participants to the same game.

In an embodiment, the music to be played is formed of a number of different channels. Each channel may represent a different sound. For example each channel may represent a different voice such as guitar voice, singing voice, rhythm voice, percussion voice or others that are in any way similar.

Each of the internal rhythm part, the “your own” part and the “other participants” part may also be on a separate channel.

For example, the total of the music to be played for any song may be considered as

M=A+B+C+D+E+F . . . ,

where there can be any number of these different variables. Each variable has its own representation, and has its own set of parameters. The variables together collectively define the music that will be played.

That is, in this system if one plays all of A-F together, one would get all the music of the whole song. However, each variable has its own characteristics and represents one part of the song, e.g., one voice.

The characteristics can include one or more of the following. The characteristic can represent whether the “voice” can be replaced (by someone's playing), or whether it cannot be replaced, or whether it can be supplemented in some way. For example, consider a guitar voice. The guitar voice may be set so that it can be totally replaced by one or more guitar players. If the guitar voice is replaceable, the guitar voice is replaced by the playing that comes from the players within the game. All the guitar sounds from the game are then replaced, and come only from what is played by the players.

The instructions forming the game may specify what it takes for replacement. For example, within the guitar, there may be a number of different guitars needed to replace, e.g., lead guitar, slide guitar, rhythm guitar and/or bass guitar. Each player can replace or supplement (e.g., play along with) one or more of those parts. When replaced, all the sounds for that voice in the game are replaced by the new sounds.

When a variable indicates that it can be supplemented, it means that during the playing of one or more instruments will supplement, but not completely remove that voice or sound. For example, the rhythm guitar may be indicated as supplementable. This may reduce the volume or the tone of the rhythm guitar, however will still leave a system-created rhythm guitar. A user can play rhythm guitar which will replace part of the sound in the system-created sounds, but will not replace the whole sound.

When a variable has a designation indicating that the sound cannot be replaced, the system will always play that part. For example, this might be a portion without which this song will make no sense. A user may be allowed to play along with some of these, but these portions cannot be replaced.

Other variable designations can also be used. For example, there may be two different guitars, both of which can be replaced when necessary.

When the game is played, the output music becomes a sum of all parts played together to make the whole including the parts from the game, as replaced by player interaction, and parts from others.

In an embodiment, one portion of the music may also come from the Internet shown generally as 150. The Internet is shown coming in through an Internet port 151, however this port may be the same wireless port shown as 120, in which case the Internet can be received by WiFi. In the embodiment, a number of players can play together, and are joined by interaction over the Internet port 151.

The above has described operation with guitars, however it should be understood that similar operations can be carried out with other instruments such as drums, wind instruments such as saxophones or flutes, etc. Moreover, a number of different instruments can play together to form the operation.

At 250, the sound is separated, so that different sounds create different at different locations. This helps the users to perceive which of these sounds come from them and which come from other players. In an embodiment, the sounds that are locally reproduced by the electronic operations entered on the controller 130 are amplified by the reconfigurable logic 136 and played by the internal speaker 132. Information indicating these sounds are also sent to any remote players. However, in an embodiment, the sounds are not played back from the console output. In another embodiment, the sounds are played from the console output, but in a deemphasized way, e.g., softer than other sounds.

This compares with the sounds which are produced by the game itself, and sounds received from others, which are played back by the console output. In one embodiment, both of those sounds may be played from speakers that are associated with the display unit, FIG. 1 shows speaker1 160 and speaker2 162, being on the game console. Of course, however, alternatively the speakers can also be on the display unit 110, e.g., speakers associated with the TV or computer monitor. According to one embodiment, the user's local sounds are played by the speaker 132, and also sent over the Internet connection 152 to any other users joining in the game.

In another embodiment, the locally produced notes may also be reproduced by the system speakers.

Another embodiment separates the sounds. System produced sounds are produced by one of the speakers 160, while the other while sounds from others are produced by the other of the speakers 162. This sound separation allows the users to distinguish between sounds that have been locally produced, and sounds produced by others. This provides more separation between the game and the simulated “band” formed of all the players.

This embodiment facilitates communicating between people to play a collective simulated concert, e.g., over the Internet. One way to do this, of course, would be to do it with friends who you know. However, another embodiment recognizes that this perhaps is another way to meet friends. Another embodiment describes a social networking component for a simulated game of this type.

According to an embodiment, users are allowed to communicate to one another to find either complete bands and/or to find new members for their band. For example, this may be carried out on a server of a computer network, as shown in FIG. 3. The server 300 is connected to the Internet, and hosts a program in its memory 305 that may include, for example, an interface that controls social networking. The server may serve content over the Internet. The content may include personal information at 310 which may include name or moniker or otherwise. In another embodiment, the social network can be anonymized so that users do not know who they are playing with specifically.

Other systems may include personal identification information such as name moniker and picture as shown. The preferences can also be set by setting the preference button 312. This allows selecting one or more different instruments to play. The user can select an instrument, and is then presented with a series of options at 322 for that instrument. For example if the user selects“guitar”, they are provided with suggestions of different kinds of guitars that they want to or like to play, e.g., from a drop down menu as shown. The user can save any of these by selecting the save button at 324, and when finished can continue using the continue button 326.

The user may then provide additional information about their preferred music type; again from a drop-down menu, or by selecting check boxes. Selecting a selection such as “metal” 332 provides additional information 334 that allows selecting other options for metal. The user can also select other options such as smooth jazz, in which the user will get options to select at 330.

Any number of different options can be presented in any form, e.g, checkbox and/or the pulldown menu.

340 represents a user's wants for a band, e.g., how many people you want in your band; what kinds of bands you want to set up, and other options. One of the other options may include the special switch-off option of the FIG. 4 embodiment as described herein.

The server 300 collects all of this information and finds different people whose characteristics match. The server may choose groups at random within the groups that match, or alternatively, may use one or more criteria, such as closest in age, or closest in geographic location. The groups are suggested at 350 according to any of the information noted above.

Another embodiment shown in FIG. 4 allows a single controller to be used to control multiple different instruments. This multi-function controller produces multiple different operations. One control produces a gaming operation which simulates the operation of a one man band. According to an embodiment, the multi-instrument controller 400 communicates with a game system 450, which can be a stand-alone console, personal computer, or other device. This may include a display also, as explained. The controller has a main body portion 410, and an extending portion 415. The extending portion 415 includes note separators such as 416 with frets 417. Each of the frets may also include finger spots 418, that can operate to allow the user to touch the notes.

The controller can also be used as a wind instrument. When so used, the “frets” 417 can represent, for example, hole locations for the user's fingers. The body of the controller also includes the usual guitar handles etc. such as 420, as well as including a portion such as 425 defining a drum pad. The body may also include an area 430 which receives a mouthpiece 435. The area with a mouthpiece includes an air sensor 436 that senses air being blown through the mouthpiece and exhausted through a hole 437 in order to simulate the amount of air that is being blown. The air sensor can be, for example, a heated wire that his cooled by the air driven across the wire, and the amount of cooling is sensed to determine the air flow.

This multi-instrument controller can therefore change between stringed instruments (guitar, bass, violin, steel guitar etc), percussion instruments (drums,) wind instrument (flute clarinet etc). or the like. The same controller can be used for simulating the playing of any of these instruments.

The controller can also be dynamically reconfigured by a reconfiguration routine shown as 455 on the controller. The reconfiguration routine, for example, reconfigures the instrument accept its inputs, and hence act like, different musical instruments at the different times.

In one embodiment, the controller may have a display unit 435. Moreover, the device may include a speaker 436 as in the other embodiments, and different configurations of the device cause different speaker profiles. For example, in the guitar mode, the output may have a guitar profile; while in the flute mode, the same key as pressed in the guitar mode, produces different output sounds.

In one embodiment, this can be used for different instruments depending on the user's selection. The user can select which instrument they wanted to play from the controller 450 or on the computer. Either the controller itself can reconfigure, or instructions from the computer can reconfigure. In this embodiment, the controller can play as any of a number of different instruments.

Another embodiment causes a change of instrument at random or at specified points. In one embodiment, for example, this may occur at random or game-preset times within the game. The game decides at any given point which instrument the or each user should be playing at that specified point in the game.

The user can also define a game profile, such as shown in FIG. 5. The game profile selects based on song parts or time in the game, which of the different parts what instrument they want to play for each of the different parts. For each entry, the user can select an instrument from a drop-down menu, and the system then reconfigures between the different items for each of these different parts.

Although only a few embodiments have been disclosed in detail above, other embodiments are possible and the inventor intends these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, the programs used herein can be any kind of program, including games, but also instrument instruction programs.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A game computer system running a program that runs an interactive game which includes information about multiple different parts of a music song, and accepts inputs which allow playing music along with said music,
where said game turns on and off the multiple different parts depending on whether a player is playing along with said music,
where at least one of said parts can be replaced by somebody is playing said part, and where a replaced part is not played by said game computer, and where a second of said parts can not be replaced by somebody is playing said part, and where said second part is played by said game computer even when said user is playing said part.

2. A computer system as in claim 1, wherein said game computer produces outputs which instruct reconfiguration of a remote game controller according to characteristics of the interactive game.

3. A computer system as in claim 1, wherein sounds for said replaced part are not output by said game computer.

4. A computer system as in claim 2, wherein said reconfiguration commands reconfiguration of a remote controller between different simulated musical instruments.

5. A computer system as in claim 4, wherein said reconfiguration commands reconfiguration of a remote controller between at least a string instrument and a wind instrument.

6. A computer system as in claim 4, wherein said reconfiguration commands reconfiguration of a remote controller between at least a string instrument and a percussion instrument.

7. A computer system as in claim 2, wherein said reconfiguration commands different sounds to be produced on said remote game controller.

8. A computer system as in claim 2, wherein said reconfiguration commands a kind of tactile feedback to be produced by said remote controller.

9. A method of playing a game on a computer that executes computer based instructions to play the game, the method comprising:
executing a program that runs an interactive game which plays a musical song, and accepts input from at least one player of the game which simulates playing music along with said musical song;
receiving inputs from a user which select which of a plurality of multiple parts are being played along with the music;
for a first of said multiple parts being played along with the music, turning off a playing of said first part by said interactive game so that said first part is played only by the user; and
for a second of said multiple parts being played along with the music, not turning off a playing of said second part by said interactive game so that said user plays said second part along with said game playing said second part

10. A method as in claim 9, further comprising producing outputs which instruct reconfiguration of a remote game controller according to characteristics of the interactive game.

11. A method as in claim 10, wherein said outputs which instruct the remote game controller to be reconfigured in a first reconfiguration for a first interactive game, and to be reconfigured in a second reconfiguration for a second interactive game, and where said controller has a different function in said first reconfiguration than in said second reconfiguration.

12. A method as in claim 11, wherein said reconfiguration commands reconfiguration of a remote controller between different simulated musical instruments.

13. A method as in claim 12, wherein said reconfiguration commands reconfiguration of a remote controller between at least simulating a string instrument and simulating a wind instrument.

14. A method as in claim 12, wherein said reconfiguration commands reconfiguration of a remote controller between at least simulating a string instrument and simulating a percussion instrument.

15. A method as in claim 12, wherein said reconfiguration commands different sounds to be produced on said remote game controller for different simulated instruments.

16. A method as in claim 10, wherein said reconfiguration commands a kind of tactile feedback to be produced by said remote controller.

17. A controller for a video game, comprising;
at least one control that is actuable by a user and produces outputs which interact with a game;
a processing part in said controller, said processing part allowing the controller to receive instructions from the game,
wherein said controller changes functions between a first simulated musical instrument and a second musical instrument.

18. A controller as in claim 17, wherein said instructions cause said controller to change functions.

19. A controller as in claim 18, wherein said processing part operates according to said instructions to cause the controller to play sounds based on instructions from the game, including a first sound to simulate said first musical instrument and a second sound to simulate said second musical instrument.

20. A controller as in claim 19, wherein said controller plays a string sound for said first musical instrument, and plays a percussion sound for said second musical instrument.
